(19) United States
(12) Patent Application Publication
(10) Pub. No.: US 2024/0251836 A1
(43) Pub. Date: Aug. 1, 2024

(54) FISH FLAVOUR AND FISH ANALOGUE PRODUCT

(71) Applicant: DSM IP ASSETS B.V., Heerlen (NL)

(72) Inventors: Mirjam Tabitha GROENEWOLD, Echt (NL); Mark James AUSTIN, Echt (NL); Julia Johanna Francisca BESSELINK, Echt (NL); Susan Georgina LATHAM, Echt (NL)

(21) Appl. No.: 18/560,853

(22) PCT Filed: May 20, 2022
(86) PCT No.: PCT/EP2022/063698

§ 371 Date: Nov. 14, 2023

(30) Foreign Application Priority Data
May 20, 2021 (EP) 21174910.6
Nov. 2, 2021 (EP) 21205928.1

(51) Int. Cl. A23L 31/15; A23J 3/14; A23J 3/16; A23J 3/22; A23L 27/00; A23L 27/20; A23L 27/23; A23P 10/40

(52) U.S. Cl. CPC A23L 31/15; A23J 3/14; A23J 3/16; A23J 3/225; A23L 27/2052; A23L 27/23; A23L 27/84; A23L 27/88; A23P 10/40

(57) ABSTRACT

The present invention relates to a fish flavour product comprising (i) a process flavour comprising an oxidized polyunsaturated fatty acid and (ii) a yeast extract comprising 5′-ribonucleotides. The present invention also relates to a fish analogue product comprising the fish flavour product.

### FIELD

The invention relates to a fish flavour product. Further, the present invention relates to a fish analogue product. Further the invention relates to a method for preparing a fish analogue product. Finally, the present invention relates to the use of the fish flavour product.

### BACKGROUND OF THE INVENTION

Fish analogues become abundantly available following the increasing need in the market for vegetarian products. Plant protein is the common ingredient in most fish analogue products. Challenges of using plant protein instead of animal protein is to provide a good texture that is perceived as real fish. Further, a challenge is to provide a fish flavour that is perceived as real fish. Plant protein is known to introduce off notes to the fish analogue product. Hence, there is a need in the art for flavour products and fish analogue products wherein the off notes from the plant protein are masked.

### DETAILED DESCRIPTION OF THE INVENTION

This object, amongst other objects is solved by providing a fish flavour product according to the appended claims.

Specifically, the present invention relates to a fish flavour product comprising (i) a process flavour comprising an oxidized polyunsaturated fatty acid and (ii) a yeast extract comprising 5′-ribonucleotides.

Surprisingly, the present inventors found that combining a process flavour comprising an oxidized polyunsaturated fatty acid with a yeast extract comprising 5′-ribonucleotides provides a fish flavour and at the same time it is suitable to mask off notes from plant protein.

The term fish flavour product, as used in the present context, means a flavouring product that is not intended to be consumed as such, which is added to food in order to impart a fish flavour. Hence, the present fish flavour product is suitable to impart a fish flavour to a food product, such as a fish analogue food product. Preferably, the present fish flavour product imparts a fish flavour when dosed with an amount of 3 wt. % in a food product.

The term process flavour, as used in the present context, means a thermally reacted product. A process flavour is not intended to be consumed as such but is added to food to impart a flavour. The process flavour comprises a glassy state resulting from the thermal reaction. The process flavour comprises an oxidized polyunsaturated fatty acid, which is stabilized in the glassy state of the process flavour. Preferably, the process flavour is stable for a time period of at least 18 months. Preferably the process flavour comprises an algal oil. Preferably the algal oil comprises (oxidized) polyunsaturated fatty acids. Preferably the fatty acids are docosahexaenoic acid (DHA) and/or eicosapentaenoic acid (EPA). Preferably the process flavour is as disclosed in WO2010/046313, which is incorporated by reference herein.

The term yeast extract is defined in the Food Chemical Codex as: “Yeast Extract comprises the water soluble components of the yeast cell, the composition of which is primarily amino-acids, peptides, carbohydrates and salts. Yeast extract is produced through the hydrolysis of peptide bonds by the naturally occurring enzymes present in edible yeast or by the addition of food-grade enzymes”.

Preferably the yeast extract comprising 5′-ribonucleotides is a dried yeast extract, preferably which is not reacted. Preferably, the present fish flavour product comprises powder particles constituting the process flavour comprising an oxidized polyunsaturated fatty acid and powder particles constituting the yeast extract comprising 5′-ribonucleotides. Hence the process flavour comprising an oxidized polyunsaturated fatty acid and the yeast extract comprising 5′-ribonucleotides are preferably separate entities, or separate powder particles.

In a preferred embodiment, the present fish flavour further comprises vitamin C (also known as ascorbic acid). Preferably the vitamin C is chosen from the group consisting of sodium ascorbate and L-ascorbic acid.

In a preferred embodiment, the fish flavour product is a homogenous powder, having a dry matter of more than 90% and/or having an amount of sodium chloride of less than 10%. More preferably having a dry matter of more than 95%. More preferably having an amount of sodium chloride of less than 5%.

In a preferred embodiment, the amount of process flavour is between 30 and 70% (w/w) of the fish flavour product. Preferably, the amount of process flavour is between 40 and 60% (w/w) of the fish flavour product.

In a preferred embodiment, the amount of yeast extract comprising 5′-ribonucleotides is between 10 and 80% (w/w) of the fish flavour product, such as between 10 and 70% (w/w) of the fish flavour product. Preferably, the amount of yeast extract comprising 5′-ribonucleotides is between 30 and 60% (w/w) of the fish flavour product. Alternatively, the amount of yeast extract comprising 5′-ribonucleotides is between 20 and 40% (w/w) of the fish flavour product.

In a preferred embodiment, the fish flavour product comprises a yeast autolysate comprising yeast cell walls. The amount of yeast autolysate is preferably between 10 and 60% (w/w) of the fish flavour product, more preferably between 15 and 40% (w/w) of the fish flavour product.

The Food Chemical Codex defines “autolysed yeast” as “the concentrated, nonextracted, partially soluble digest obtained from food-grade yeast. Solubilization is accomplished by enzyme hydrolysis or autolysis of yeast cells. Food-grade salts and enzymes may be added. Yeast, autolyzed, contains both soluble and insoluble components derived from the whole yeast cell. It is composed primarily of amino acids, peptides, carbohydrates, fats, and salts”.

In a preferred embodiment, the present yeast extract comprising 5′-ribonucleotides comprises an amount of free asparagine, based on dry matter, which is not higher than 1 mg/g, preferably not higher than 0.2 mg/g, more preferably not higher than 0.1 mg/g of the yeast extract. The advantage of yeast extracts having a low amount of asparagine is that no or less acrylamide is formed during the Maillard reaction when preparing a fish analogue product. Particularly if the yeast extract is used on the exterior of the fish analogue product, there where the temperature is highest during preparing, it is advantageous to use a low asparagine yeast extract.

Preferably, the present process flavour comprising an oxidized polyunsaturated fatty acid and/or the present fish flavour product comprises an amount of acrylamide, based on product dry matter, of lower than 800 ppb, preferably lower than 600 ppb, preferably lower than 400 ppb, preferably lower than 200 ppb. Other preferred ranges are from 10 to 800 ppb, such as from 20 to 600 ppb, 50 to 400 ppb, or 100 to 200 ppb.

In an embodiment, the yeast extract comprising 5′-ribonucleotides comprises an amount of gluten of less than 100 ppm, preferably less than 50 ppm gluten, more preferably less than 40 ppm gluten, more preferably less than 30 ppm gluten, based on salt free dry matter of the yeast extract. This is advantageous in that the low gluten yeast extracts provide a fish flavour product having an improved food label, without the necessity to mention the amount of gluten on the product.

Therefore, the present fish flavour product comprises preferably an amount of gluten of less than 100 ppm, preferably less than 50 ppm gluten, more preferably less than 40 ppm gluten, more preferably less than 30 ppm gluten, based on dry matter of the fish flavour product.

In a preferred embodiment, the present yeast extract comprises from 25 to 55 wt. % 5-ribonucleotides, wherein the yeast extract comprises 5 to 20 wt. % 5-AMP and 5 to 20 wt. % 5-GMP, preferably in a 5′-AMP/5′-GMP ratio of between 0.85 and 1.25, the weight percentages being based on the dry weight of the yeast extract. Preferably the yeast extract comprises from 8 to 16 wt. % 5′ AMP and 8 to 16 wt. % 5′-GMP.

In a preferred embodiment, the present fish flavour product is suitable to mask vegetable off notes from plant protein in a fish analogue product. For example the present fish flavour product is suitable for masking off notes from soy or rice protein, or from texturized vegetable protein, such as soy or rice texturized vegetable protein. Preferably soy or rice texturized vegetable protein in a fish analogue product.

Given the advantageous result of the present fish flavour (product) in fish analogues, the present invention relates, according to another aspect, to a fish analogue product comprising a texturized vegetable protein, a binder, water, and a fish flavour product as defined herein, wherein the fish flavour product is present in an amount of 1 to 5% (w/w) of the fish analogue product, preferably wherein the fish analogue product further comprises vitamin C. Surprisingly, the present inventors found that combining a process flavour comprising an oxidized polyunsaturated fatty acid with a yeast extract comprising 5′-ribonucleotides provides a fish flavour product that is suitable to mask off notes from plant protein. Further, the present inventors found that the fish analogue products have an improved fish flavour in comparison to fish analogue products without the present fish flavour product.

The term ‘fish analogue product’, or fish substitute, as used in the present context means a product that does not comprise animal protein and thus is suitable to be used as a vegetarian or vegan fish alternative product and has an appearance mimicking a fish product.

Preferably, the present fish analogue product comprises vitamin C, preferably chosen from the group consisting of sodium ascorbate and L-ascorbic acid. Preferably the present fish analogue product comprises from 0.0001 to 0.1 wt. % vitamin C, more preferably from 0.001 to 0.05 wt. % vitamin C.

The present fish analogue product comprises texturized vegetable protein. Preferably the texturized vegetable protein is an extruded vegetable protein product. This can cause a change in the structure of the protein which results in a fibrous, spongy matrix, similar in texture to meat. The textured vegetable protein can be rehydrated or dehydrated. Preferably, the texturized vegetable protein is selected from rice protein, soy bean protein, pea protein, lentil protein, lupin bean protein, wheat gluten, rapeseed protein, fava bean protein or a combination thereof.

Preferably, the present fish analogue product comprises an amount of fish flavour product from 2 to 5% (w/w), or 2.5 to 4.5% (w/w) or around 3% (w/w) of the fish analogue product.

Preferably, the present fish analogue product comprises texturized vegetable protein in an amount from 5 to 70% (w/w), preferably an amount of 10 to 25% (w/w), preferably 8 to 20% (w/w), preferably 10 to 15% (w/w) of the fish analogue product. Or 50 to 70% (w/w) of the fish analogue product.

Preferably, the present fish analogue product comprises texturized vegetable protein with a protein amount from 50 to 99% (w/w), preferably an amount of 55 to 90% (w/w), preferably 60 to 85% (w/w) of the texturized vegetable protein.

Preferably, the present texturized vegetable protein is hydrated towards an amount of water of more than 10% (w/w) of the texturized vegetable protein, preferably an amount of water from 20 to 80% (w/w) of the texturized vegetable protein, preferably an amount of water from 30 to 70% (w/w) of the texturized vegetable protein.

In an embodiment, the present binder is chosen from the group consisting of gellan gum, methylcellulose, egg white, wheat gluten, fermented protein, beta-glucan, calcium-alginate gels and starch based binders, or a combination thereof.

The term “binder” or “binding agent” as used herein relates to a substance for holding together particles and/or fibres in a cohesive mass. It is an edible substance that in the final product is used to trap components of the foodstuff with a matrix for the purpose of forming a cohesive product and/or for thickening the product. Binding agents of the invention may contribute to a smoother product texture, add body to a product, help retain moisture and/or assist in maintaining cohesive product shape; for example by aiding particles to agglomerate. Preferably the present fish analogue product comprises an amount of binder from 0.5 to 5% (w/w), preferably from 1 to 4% (w/w), such as from 2 to 3% (w/w).

The binder may be methyl cellulose. The methyl cellulose might be present in an amount of 0.5 to 2% (w/w) such as from 1 to 2% (w/w) of the fish analogue product.

In a preferred embodiment the binder is gellan gum and the present gellan gum is high acyl gellan gum. Preferably the high acyl gellan gum is a polymer comprising various monosaccharides linked together to form a linear primary structure and the gum gels at temperatures of greater than 60 degrees centigrade. In some high acyl gellan gums, the gel temperature may be approximately 70 degrees centigrade or greater. In some high acyl gellan gums, the gel temperature may be approximately between 70 degrees centigrade and 80 degrees centigrade The properties of the high acyl gellan gum polymer may vary depending at least in part on its source, how it was processed, and/or the number and type of acyl groups present on the polymer.

Preferably, the amount of gellan gum in the present fish analogue product is within the range of 0.1 to 4% (w/w), preferably 0.2 to 3% (w/w), more preferably 0.5 to 1.0% (w/w) of the fish analogue product.

Preferably, the present gellan gum, or the present high acyl gellan gum, has a single gel setting temperature that is within the range of 70° C. to 90° C. The advantage of high acyl gellan gum is that it forms soft and flexible gels, beneficial in providing a good texture of a fish analogue product, without introducing off flavors to the product. Preferably, the present gellan gum, or the present high acyl gellan gum, has more than 40% acetyl and more than 45% glyceryl residual substitutions per repeating unit.

In a preferred embodiment, the present fish analogue product further comprises a nutrient, preferably wherein the nutrient comprise both vitamins and minerals, preferably vitamins chosen from the group consisting of B2, B3, B5, B6, B12 and vitamin D, preferably minerals chosen from the group consisting of iodine, iron, selenium and zinc. The term “nutrient” as used herein relates to a substances that provide nutritional value to the present fish analogue product, such as vitamins, minerals, trace elements and antioxidants for example. The advantage of adding these nutrients is that the present fish analogue product more closely resembles the nutritional value of fish, without introducing off flavors to the fish analogue product.

In an embodiment, the present fish analogue product further comprises a vegetable oil and/or a vegetable fat. The vegetable oil and/or fat can be an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, or rice bran oil; or margarine or other hydrogenated fats. In some embodiments, for example, the oil is algal oil. In a preferred embodiment, the present plant oil is sunflower oil and/or the present plant fat is coconut fat.

Preferably, the present fish analogue product comprises an amount of vegetable oil, preferably within the range from 2 to 20% (w/w) of the fish analogue product, such as from 5 to 15% (w/w) or from 7 to 12% (w/w).

Preferably, the present fish analogue product comprises an amount of vegetable fat within the range from 0.5 to 5% (w/w) of the fish analogue product, such as from 1 to 3% (w/w) of the fish analogue product.

Preferably, the present fish analogue product comprises salt, preferable NaCl. The amount of salt is preferably within the range of 0.001 to 5% (w/w) of the present fish analogue product.

In an embodiment, the present fish analogue product comprises an amount of water within the range of 10 to 80% (w/w), preferably 30 to 60% (w/w). Alternatively the amount of water is within the range of 10 to 25% (w/w) of the fish analogue product.

In a preferred embodiment, the present fish analogue product is a battered fish analogue, a fish salad analogue, a fish ball analogue, a salmon ball analogue, a tuna salad analogue or crab salad analogue.

Preferably, a battered fish analogue comprising 50 to 70% (w/w) of rice texturized vegetable protein, 10 to 30% (w/w) water, 1 to 10% (w/w) oil and/or fat.

Preferably a fish salad analogue, comprising 10 to 30% (w/w) of texturized soy protein, 20 to 60% (w/w) water, 20 to 40% (w/w) vegan mayonnaise.

Preferably a fish ball, comprising 10 to 30% (w/w) of texturized soy protein, 40 to 70% (w/w) water, 1 to 15% (w/w) oil and/or fat.

According to another aspect the present invention relates to a method for preparing a fish analogue product, comprising mixing a texturized vegetable protein, a binder, water, and a fish flavour product as defined herein, and preparing the fish analogue product. The step of preparing the fish analogue product may comprise a heating step, such as frying in a pan or oil, but may also comprise a mixing step. The letter is for example used for the preparing a fish salad type of fish analogue product.

According to another aspect, the present invention relates to the use of the present fish flavour product for masking vegetable off notes from plant protein in a fish analogue product. For example for masking off notes from soy or rice protein, or from texturized vegetable protein, such as soy or rice texturized vegetable protein. Further, the present invention relates to the use of the present fish flavour product for providing a fish flavour to fish flavour analogue products.

In another aspect, the present invention relates to the use of vitamin C for enhancing the fish flavour in a fish analogue product. Preferably wherein the vitamin C is chosen from the group consisting of sodium ascorbate and L-ascorbic acid. Preferably wherein the vitamin C is used in an amount 0.0001 to 0.1 wt. %, more preferably from 0.001 to 0.05 wt. % of the fish analogue product.

The present invention is further illustrated using the examples below.

### EXAMPLES

### Example 1 Preparation of Fish Flavour

The ingredients as shown in table 1 were blended to provide two fish flavour products.

TABLE 1

| | Fish flavour 1 | Fish flavour 2 |
|---|---|---|
| Process flavour according to | 50% (w/w) | 50% (w/w) |
| WO2010046313 | | |
| Yeast extract comprising 5′- | 50% (w/w) | 25% (w/w) |
| ribonucleotides | | |
| Yeast autolysate according to | | 25% (w/w) |
| WO2009007424 | | |

### Example 2 Preparation of Battered Fish Analogue

Battered fish analogues were prepared using the ingredients shown in table 2. The frozen Rice TVP was washed and soaked for between 3 and 6 hours. The Rice TVP was drained thoroughly. The high acyl gellan gum was dissolved in the oil, the methylcellulose was blended with the oil and high acyl gellan gum, water was added slowly to form an emulsion. The TVP and emulsion portion was blended with the remaining ingredients and formed into desired nugget or fish shaped pieces. The fish pieces were frozen before being coated with flour, battered or breadcrumbed and deep fried for 1 minute at 180° C. The fish analogues were blast frozen and stored at −18° C. until needed. The fish analogues were tested on flavour. Preparation: defrost before use. Preheat an AirFryer or Oven to 180° C. and bake for 8-12 minutes until the core temperature reached 72° C.

TABLE 2

| Ingredient (in | Control fish | Improved fish | Improved fish | Improved fish | Improved fish |
|---|---|---|---|---|---|
| w/w %) | analogue | analogue 1 | analogue 2 | analogue 3 | analogue 4 |
| Fish flavour 1 of | | 3.50 | | 3.50 | |
| example 1 | | | | | |
| Fish flavour 2 of | | | 3.50 | | 3.50 |
| example 1 | | | | | |
| Vitamin C (sodium | | | | 0.006 | 0.012 |
| ascorbate) | | | | | |
| Rice TVP | 62.94 | 62.94 | 62.94 | 62.94 | 62.94 |
| Water | 16.57 | 16.57 | 16.57 | 16.57 | 16.57 |
| Sunflower oil | 6.63 | 6.63 | 6.63 | 6.63 | 6.63 |
| Coconut fat pieces | 6.00 | 6.00 | 6.00 | 6.00 | 6.00 |
| Rice flour | 2.48 | 2.48 | 2.48 | 2.48 | 2.48 |
| Methylcellulose | 0.83 | 0.83 | 0.83 | 0.83 | 0.83 |
| High acyl gellan | 0.33 | 0.33 | 0.33 | 0.33 | 0.33 |
| gum | | | | | |
| Salt | 0.80 | 0.37 | 0.63 | 0.37 | 0.37 |
| Maltodextrin | 3.42 | 0.35 | 0.09 | 0.34 | 0.34 |

The results are that the control fish analogue has a rice TVP note, which is masked in the improved fish analogues. Improved fish analogue 1 provides a strong dark meat fish profile. Improved fish analogue 2 provides a more fatty fish profile with enhanced juicy aftertaste. Improved fish analogue 3 and 4 provide a stronger fishy profile and stronger fishy aroma.

### Example 3 Preparation of Fish Analogue Salad

Fish salad fish analogue were prepared using the ingredients in table 3. The soy TVP was hydrated with the water, steamed at 85° C./100% humidity for 25 minutes and cooled. The Soy TVP was chopped to size (flakes). All Ingredients were blended together and the fish analogue salad stored in the refrigerator until needed and given a shelf life of 10 days.

TABLE 3

| | Control | Improved | Improved |
|---|---|---|---|
| | fish | fish | fish |
| Ingredient (in w/w %) | analogue | analogue 1 | analogue 2 |
| Fish flavour 1 of example 1 | | 3.00 | |
| Fish flavour 2 of example 1 | | | 3.00 |
| Soy TVP | 16.25 | 16.25 | 16.25 |
| Water | 40.50 | 40.50 | 40.50 |
| Vegan mayonnaise | 28.50 | 28.50 | 28.50 |
| Gherkins | 7.50 | 7.50 | 7.50 |
| Tomato puree | 2.75 | 2.75 | 2.75 |
| Salt | 0.75 | 0.60 | 0.38 |
| Sugar | 0.40 | 0.40 | 0.40 |
| White pepper | 0.15 | 0.15 | 0.15 |
| Black pepper | 0.30 | 0.30 | 0.30 |
| Maltodextrin | 2.90 | 0.05 | 0.27 |

The results are that the control fish analogue has a soy TVP note, which is masked in the improved fish analogues. Improved fish analogue 1 provides a strong dark meat fish profile. Improved fish analogue 2 provides a more fatty fish profile with enhanced juicy aftertaste.

### Example 4 Preparation of Fish Balls Analogue

Fish ball analogues were prepared using the ingredients in table 4. The soy TVP was hydrated with water 1 and steamed at 85° C./100% humidity for 25 minutes. Once cooled the Soy TVP was chopped to correct size (flakes). The high acyl gellan gum was dissolved in the oil, the methylcellulose was blended with the oil and high acyl gellan gum, water 2 was added slowly to form an emulsion. The TVP and emulsion were combined with the remaining ingredients and formed into ˜25 gram balls and chilled. Once the balls were firm they were fried in oil at a temperature of 180° C. for 1 minute until golden. The fish balls analogues were blast frozen and stored at −18° C. until further tested. The fish analogues were tested on flavour. Preparation: defrost before use. Preheat an AirFryer or Oven to 180° C. and bake for 6-10 minutes until the core temperature reached 72° C.

TABLE 4

| | Control | Improved | Improved |
|---|---|---|---|
| | fish | fish | fish |
| Ingredient (in w/w %) | analogue | analogue 1 | analogue 2 |
| Fish flavour 1 of example 1 | | 3.00 | |
| Fish flavour 2 of example 1 | | | 3.00 |
| Soy TVP | 15.28 | 15.28 | 15.28 |
| Water 1 (hydration TVP) | 38.22 | 38.22 | 38.22 |
| High acyl gellan gum | 0.43 | 0.43 | 0.43 |
| Methylcellulose | 1.08 | 1.08 | 1.08 |
| Sunflower oil | 8.62 | 8.62 | 8.62 |
| Water 2 (hydrocolloids) | 21.54 | 21.54 | 21.54 |
| Salt | 1.0 | 0.85 | 0.63 |
| Maltodextrin | 5.64 | 2.79 | 3.01 |
| Egg white powder | 2.00 | 2.00 | 2.00 |
| dextrose | 1.00 | 1.00 | 1.00 |
| Herbs & spices | 2.19 | 2.19 | 2.19 |
| Coconut fat | 3.00 | 3.00 | 3.00 |

The results are that the control fish analogue has a soy TVP note, which is masked in the improved fish analogues. Improved fish analogue 1 provides a strong dark meat fish profile. Improved fish analogue 2 provides a more fatty fish profile with enhanced juicy aftertaste.

### Example 5 Preparation of Fish Flavour with Vitamins

The fish flavours 1 and 2 of example 1 were combined with vitamin A, C, D or E in a vegetarian fish sauce, as using the recipes of table 5 below. Ingredients of the vegetarian fish sauce were: salt solution, sugar, seaweed extract, soybean protein, yeast extract, and vinegar.

TABLE 5

| | Fish sauce (49 | Fish flavour | |
|---|---|---|---|
| Sample | gram) | (0.05 gram) | Vitamin |
| 1 | Thai taste veg fish | — | — |
| | sauce | | |
| 2 | Thai taste veg fish | 2 | — |
| | sauce | | |
| 3 | Thai taste veg fish | 2 | Vit A as vitamin A acetate |
| | sauce | | (0.58 mg) from DSM |
| 4 | Thai taste veg fish | 2 | Vit C as sodium ascorbate |
| | sauce | | (8.47 mg) from DSM |
| 5 | Thai taste veg fish | 2 | Vit D as cholecalciferol |
| | sauce | | (0.34 mg) from DSM |
| 6 | Thai taste veg fish | 2 | Vit E as vitamin E acetate |
| | sauce | | (2.19 mg) from DSM |
| 7 | Thai taste veg fish | — | Vit C (8.47 mg) as sodium |
| | sauce | | ascorbate from DSM |
| 8 | Thai taste veg fish | 1 | Vit C (8.47 mg) as sodium |
| | sauce | | ascorbate from DSM |

Subsequently, the fish sauces were tested by a test panel of 5 panelist. The observations are shown in table 6 below.

TABLE 6

| Sample | observations |
|---|---|
| 1 | Salty |
| 2 | Salty, fishy flavour |
| 3 | Salty, fishy flavour, no difference with sample 2 |
| 4 | Salty, stronger fish flavour, more oily mackerel type flavour |
| 5 | Salty, fishy flavour, no difference with sample 2 |
| 6 | Salty, fishy flavour, no difference with sample 2 |
| 7 | Sample 1 vs 7: no differences |
| 8 | Sample 4 vs 8: both have strong fishy flavour |

The results show that addition of vitamin C further improves the fishy flavour.

### Example 6 Preparation of Instant Fish Soup with Different Grades of Vitamin C

A light creamy fish soup was prepared by blending and heating the following ingredients of table 7.

TABLE 7

| Ingredient (in w/w %) | Control | Reference |
|---|---|---|
| Fish flavour 1 | | 4.00 |
| Starch | 28.00 | 28.00 |
| Maltodextrin | 25.36 | 21.44 |
| Wheat flour | 16.00 | 16.00 |
| Salt | 12.50 | 12.42 |
| Whey powder | 10.00 | 10.00 |
| Tomato | 1.50 | 1.50 |
| Onion | 1.50 | 1.50 |
| Garlic | 1.50 | 1.50 |
| Fennel seed | 1.30 | 1.30 |
| Lactic acid | 0.70 | 0.70 |
| Coriander seed | 0.50 | 0.50 |
| White pepper | 0.50 | 0.50 |
| Dill tips | 0.50 | 0.50 |
| Dill aroma | 0.14 | 0.14 |
| Total | 100 | 100 |

Subsequently, 6-7 gram of the ingredients was blended in 100 ml water. Different grades of vitamin C were added to a vegan instant fish soup and the results are shown below.

TABLE 8

| Sample | Product | Vitamin addition | Observations |
|---|---|---|---|
| 1 control | Light creamy vegan instant fish soup | | |
| | without fish flavour 1 | | |
| 2 reference | Light creamy vegan instant fish soup | | |
| | with fish flavour 1 | | |
| 3 low | Light creamy vegan instant fish soup | Vit C (0.017 g) as | Stronger fish |
| vitamin C | with fish flavour 1 | sodium ascorbate | flavour |
| | | from DSM | No clear difference |
| 4 low | Light creamy vegan instant fish soup | Vit C (0.015 g) as | between sample 3 |
| vitamin C | with fish flavour 1 | L-ascorbic acid | and 4 |
| | | from Sigma-Aldrich | |
| 5 high | Light creamy vegan instant fish soup | Vit C (0.034 g) as | Stronger fish |
| vitamin C | with fish flavour 1 | sodium ascorbate | flavour |
| | | from DSM | No clear difference |
| 6 high | Light creamy vegan instant fish soup | Vit C (0.030 g) as | between sample 5 |
| vitamin C | with fish flavour 1 | L-ascorbic acid | and 6 |
| | | from Sigma-Aldrich | |

### Example 7 Analysis of Volatiles of Fish Flavours

Fish flavour 1 and fish flavour 2 of example 1 were analyzed on volatiles, with and without addition of vitamin C, using solid phase microextraction coupled to a Gas Chromatography High resolution Mass Spectrometry-Qexactive Thermo Fisher system (SPME-GC-HRMS). The fish flavour (abbreviated as FF) was added, with and without vitamin C (sodium ascorbate from DSM), as is shown in table 9 below.

TABLE 9

| | | Wt. % | | Wt. % | Wt. % |
|---|---|---|---|---|---|
| | | fish | Wt. % | salt | salt |
| product | code | flavour | Vit C | added | total |
| Water + fish flavour 1 | FF1 | 0.25 | 0 | 0.022 | 0.0293 |
| Water + fish flavour 1 + | FF1/ | 0.25 | 0.017 | 0.018 | 0.0293 |
| vit C | vitC | | | | |
| Water + fish flavour 2 | FF2 | 0.25 | 0 | 0.005 | 0.0293 |
| Water + fish flavour 2 + | FF2/ | 0.25 | 0.017 | 0 | 0.0293 |
| vit C | vitC | | | | |
| Water + vit C | VitC | 0 | 0.017 | 0.24 | 0.0293 |

Samples of 1 gram from the products were taken into 10 ml Head Space vials for further analysis, using the analytical method indicated below.

### SPME Conditions

Fiber: 50/30 μm DVB/Carboxen/PDMS (2 cm of Supelco)
Pre-conditioning: 50° C. for 15 minutes with agitation (250 rpm/10 sec on/3 sec off)
Extraction: 50° C. for 20 minutes—vial penetration 31 mm
Desorption: GC inlet—front for 2 min, penetration 54 mm
Post-bake: 10 min for 250° C.
Bake out penetration: 43 mm

### GC Conditions

Column: DB5-MS (30 m×0.250 mm, 0.25 μm) from Agilent J&W
Carrier gas: Helium 1.0 ml/min (constant flow)
Oven: 45° C. for 2 minutes, ramping 5° C./min until 175° C., followed by ramping at 25° C./min until 250° C. and maintaining for 5 min. Total analysis time of 36 min.

### Mass Spectrometry Conditions

lonisation: El+
Source temperature: 230° C.
Electron energy 70 eV
Resolution: 120 k
ACG Target: 1 000 000
Mass range: 33-500 Da (FS)
Filament on delay: 2 min
Use lock masses: standard (best)

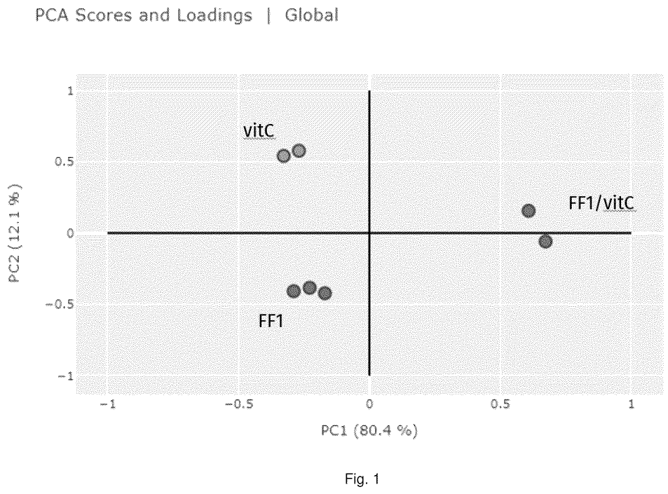

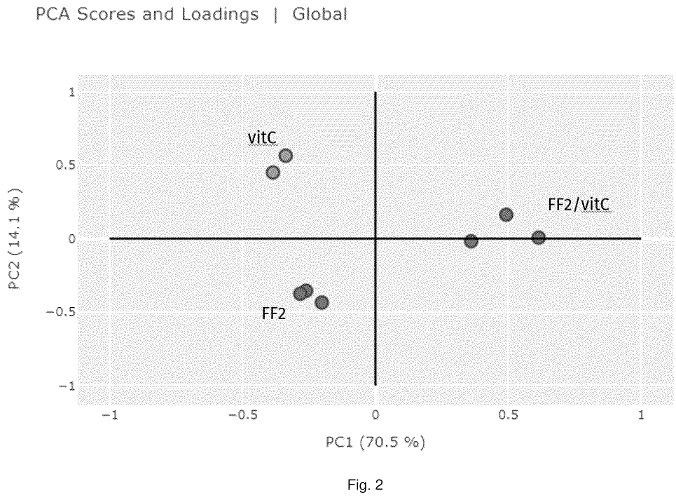

Identification was based on MS fragmentation and using Mass Spectral online Libraries (NIST20, FFNSC3). Peak areas were obtained by deconvolution and integration of the peak of the extracted-ion chromatogram for each identified compound using Compound discoverer software. The peak areas were then plotted in a Principal Component Analysis (PCA) and compared per samples, as is shown in FIGS. 1 and 2.

### Results

FIG. 1 shows the triplicate samples of FF1 and the duplicate samples of FF1/vitC and vitC. The figure shows that the samples are really different from each other. The main differences are observed between vitC and FF1 samples compare to FF1/vitC (PC1 axis). This indicates that the volatiles composition is different when adding vitamin c in the FF1 sample. The volatile compounds (data not shown) ketones and aldehydes are increased after addition of vitamin c.

FIG. 2 shows the triplicate samples of FF2 and the duplicate samples of FF2/vitC and vitC. The figure shows that the samples are really different from each other. The main differences are observed between vitC and FF2 samples compare to FF2/vitC (P01 axis). This indicates that the volatiles composition is different when adding vitamin c in the FF2 sample. The volatile compounds (data not shown) ketones and aldehydes are increased after addition of vitamin c.

### Example 8

### Preparation of Crab Analogue Salad

A crab analogue salad was prepared using the ingredients shown in table 10 below.

TABLE 10

| Ingredients | % (wt) |
|---|---|
| Fish flavour 2 | 1.45 |
| Soy TVP | 16.25 |
| Water (hydration) | 40.50 |
| Vegan Mayonnaise | 28.50 |
| Tomato Puree | 2.75 |
| Diced Gherkins | 7.50 |
| Maltodextrin | 2.32 |
| Salt | 0.50 |
| Black Pepper | 0.10 |
| White Pepper | 0.10 |
| DSM Vitamin & Mineral Premix | 0.03 |

The crab salad was tested and provided a delicate crab, slightly sweet, clean withe crab meat profile.

### Example 9

### Plant Based Salmon Balls

Plant based salmon balls were prepared using the ingredients listed in table 11 below.

TABLE 11

| Ingredients | % (wt) |
|---|---|
| Fish flavour 1 | 1.50 |
| DSM Plant Masker | 0.50 |
| Pea TVP (Vestkorn P6511C TVP) | 16.80 |
| Total Water (TVP hydration + Texture) | 62.60 |
| Sunflower Oil | 9.90 |
| Wheat Flour | 4.90 |
| Methylcellulose | 1.25 |
| Lemon Juice | 1.00 |
| Salt | 0.73 |
| Herbs & Spices (Parsley, Dill & Pepper) | 0.26 |
| High acyl gellan gum (Gellaneer ® HD, DSM) | 0.50 |
| DSM Natural Colour Redivivo ® | 0.03 |
| DSM Vitamin & Mineral Premix | 0.03 |

The salmon balls were tested and had an authentic and natural tasting salmon flavor and aroma.

### Example 10

### Plant Based Tuna Sandwich Salad

A plant based tuna salad was prepared using the ingredients of table 12.

TABLE 12

| Ingredients | % (wt.) |
|---|---|
| Fish flavour 1 | 1.50 |
| Pea TVP (Vestkorn P6511C TVP) | 8.60 |
| TVP fibers (mixed plant proteins) | 10.0 |
| Water (hydration of TVP) | 21.40 |
| Vegan Mayonnaise | 53.00 |
| Tomato Puree | 4.00 |
| Maltodextrin | 0.96 |
| Salt | 0.31 |
| White Pepper | 0.10 |
| Black Pepper | 0.10 |
| DSM Vitamin & Mineral Premix | 0.03 |

The tuna salad was tested and provided a strong, rounded tuna type flavour, dark meaty fish, and clean canned tuna type flavour.

### Example 11

### Vegan Caesar Salad Dressing

Five different types of vegan Caesar salad dressings were prepared using the ingredients of table 13.

TABLE 13

| Type Caesar salad/Ingredients | Base | Umami | Flavors | Modumax ® | Fish |
|---|---|---|---|---|---|
| Multirome ® LS (DSM) | | 0.2 | 0.2 | 0.2 | 0.2 |
| Gistex ® XII LS (DSM) | | 0.08 | 0.08 | 0.08 | 0.08 |
| B Carotene 10% EM Yellow (DSM) | 0.0015 | 0.0015 | 0.0015 | 0.0015 | 0.0015 |
| Natural Buttermilk Type Flavor 10170L (DSM) | | | 0.05 | 0.05 | 0.05 |
| Natural Romano Cheese Type Flavor 11523D | | | 0.85 | 0.85 | 10.85 |
| (DSM) | | | | | |
| Natural Milk Type Flavor 300418L (DSM) | | | 0.5 | 0.5 | 0.5 |
| ModuMax ® (DSM) | | | | 0.08 | 0.08 |
| Fish flavour 2 (of example 1) | | | | | 0.2 |
| Starch | 2.6 | 2.6 | 2.6 | 2.6 | 2.6 |
| ClariXan RXC 80F (DSM) | 0.02 | 0.02 | 0.02 | 0.02 | 0.02 |
| Salt | 0.93 | 0.93 | 0.93 | 0.93 | 0.93 |
| Spirit Vinegar powder | 0.35 | 0.35 | 0.35 | 0.35 | 0.35 |
| Lactic acid powder | 0.15 | 0.15 | 0.15 | 0.15 | 0.15 |
| Emulsifier CM 1120 | 0.8 | 0.8 | 0.8 | 0.8 | 0.8 |
| Sunflower oil | 20 | 20 | 20 | 20 | 20 |
| Water | 72.89 | 72.89 | 72.89 | 72.89 | 72.89 |
| Maltodextrin | 1.96 | 1.68 | 0.28 | 0.2 | 0 |
| Garlic powder | 0.1 | 0.1 | 0.1 | 0.1 | 0.1 |
| White pepper | 0.2 | 10.2 | 0.2 | 0.2 | 0.2 |
| Total | 100 | 100 | 100 | 100 | 100 |

The five Caesar salad dressings were tasted and the ‘Fish’ type (with addition of fish flavour 2) gave a delicate fish taste direction. The ‘Modumax®’ type Caesar gave a strong umami base and mouthfeel. The ‘flavor’ type Caesar resulted in creaminess and cheesiness.

1. A fish flavour product comprising (i) a process flavour comprising an oxidized polyunsaturated fatty acid and (ii) a yeast extract comprising 5′-ribonucleotides.

2. The fish flavour product according to claim 1, further comprising a yeast autolysate comprising yeast cell walls.

3. The fish flavour product according to claim 1, further comprising vitamin C.

4. The fish flavour product according to claim 1, wherein the amount of process flavour is between 30 and 70% (w/w) of the fish flavour product and/or wherein the amount of yeast extract comprising 5′-ribonucleotides is between 10 and 80% (w/w) of the fish flavour product.

5. The fish flavour product according to claim 1, which is a homogenous powder, having a dry matter of more than 90% and/or having an amount of sodium chloride of less than 10%.

6. A fish analogue product comprising a texturized vegetable protein, a binder, water, and a fish flavour product as defined in claim 1, wherein the fish flavour product is present in an amount of 1 to 5% (w/w) of the fish analogue product, optionally wherein the fish analogue product further comprises vitamin C.

7. The fish analogue product according to claim 6, wherein the binder is chosen from the group consisting of gellan gum, methylcellulose, egg white, wheat gluten, calcium-alginate gels and starch based binders.

8. The fish analogue product according to claim 6, wherein the texturized vegetable protein is selected from rice protein, soy bean protein, pea protein, lentil protein, lupin bean protein, wheat gluten, rapeseed protein, fava bean protein or a combination thereof.

9. The fish analogue product according to claim 6, which is a battered fish analogue, a fish salad analogue, or a fish ball analogue.

10. The fish analogue according to claim 9, which is a battered fish analogue comprising 50 to 70% (w/w) of rice texturized vegetable protein, 10 to 30% (w/w) water, 1 to 10% (w/w) oil and/or fat.

11. The fish analogue according to claim 9, which is a fish salad analogue, comprising 10 to 30% (w/w) of texturized soy protein, 20 to 60% (w/w) water, 20 to 40% (w/w) vegan mayonnaise.

12. The fish analogue according to claim 9, which is a fish ball, comprising 10 to 30% (w/w) of texturized soy protein, 40 to 70% (w/w) water, 1 to 15% (w/w) oil and/or fat.

13. A method for preparing a fish analogue product, comprising mixing a texturized vegetable protein, a binder, water, and a fish flavour product as defined in claim 1, and preparing the fish analogue product.

14. A product comprising a fish flavour product as defined in claim 1 for masking vegetable off notes from plant protein in a fish analogue product or for providing a fish flavour to fish flavour analogue products.

15. A product comprising vitamin C for enhancing the fish flavour in a fish analogue product.
